(19) United States
(12) Patent Application Publication
(10) Pub. No.: US 2005/0037294 A1
(43) Pub. Date: Feb. 17, 2005

(54) Stabilized p-phenylenediamine-type photographic color developers in free base form

(76) Inventor: Phillip Montgomery Hudnall, Kingsport, TN (US)

Correspondence Address: Mark L. Davis, P.O. Box 9293, Gray, TN, 37615-9293, US

(21) Appl. No.: 10/667,120

(22) Filed: Sep. 16, 2003

Related U.S. Application Data
(62) Division of application No. 09/982,130, filed on Oct. 18, 2001, now abandoned.
(60) Provisional application No. 60/241,814, filed on Oct. 19, 2000.

(51) Int. Cl. G03C 5/18

(52) U.S. Cl. 430/467

(57) ABSTRACT

A stabilized p-phenylenediamine color developer solution having about 10 to 40 weight percent of a p-phenylenediamine free base color developer, about 40 to 70 weight percent of a hydroxy-containing organic solvent for the p-phenylenediamine free base color developer, and about 1 to 40 weight percent of a preservative for the p-phenylenediamine free base color developer, wherein the weight percentages are based on the total weight of the stabilized solution. Another aspect are processes for making stabilized p-phenylenediamine color developer solutions. Another embodiment is a p-phenylenediamine color developer solid having from 50 to about 99 weight percent of a p-phenylenediamine free base color developer, and from about 1 to 50 weight percent of a preservative for the p-phenylenediamine free base color developer, wherein the weight percentages are based on the total weight of the composition. Another aspect is a process for making the stabilized solid p-phenylenediamine color developer.

### CROSS REFERENCE TO RELATED APPLICATIONS

Benefit is claimed to the earlier filed application having U.S. Ser. No. 60/241,814 filed Oct. 19, 2000, the entire disclosure of which is incorporated herein by reference.

### BACKGROUND OF THE INVENTION

1. Field of the Invention

This invention pertains to p-phenylenediamine-type photographic color developer compositions and methods for making p-phenylenediamine-type photographic color developers in their free-base form. More specifically, this invention pertains to useful concentrated solutions and solid compositions of such free-base forms of p-phenylene-diamine color developers, and to processes for the manufacture thereof.

2. Background of the Invention

The present invention relates to the manufacture of solutions of p-phenylenediamine-type photographic color developers in the free base form, i.e., a phenylenediamine devoid, or essentially devoid, of any acid addition salt of the phenylenediamine p-Phenylenediamine free bases have broad industry utility for the preparation of photographic finishing formulations which require a p-phenylenediamine color developer in the free base, rather than the salt, form.

The photographic finishing industry is comprised of three primary segments: the manufacture of photographic chemicals to supply photochemical formulators, the formulation of these chemicals into useful compositions for photochemical processing, and the processing of sensitized photographic color elements. Formulated photographic processing (photofinishing) solutions provided to the processors are complex, multi-part, multi-component mixtures, the specific compositions of which vary significantly according to the intended use and the formulator. Generally, the types of materials which are ultimately mixed and delivered to the processing bath include water; solubilizing agents, e.g., organic co-solvents; bases for pH control; color developing agents or color developers; preservatives; sequestering agents; buffering agents; clarifying agents; stain-reducing agents; anti-bacterial or anti-fungal agents; surfactants, and other function-specific materials.

The active component of the formulation which effects the formation of color upon processing (development) of the sensitized photographic color element (exposed film) is the free-base color developer. The color developers most commonly present in photofinishing compositions are p-phenylenediamine compounds such as N,N-dialkyl-p-phenylenediamines. These N,N-dialkyl-p-phenylenediamines vary in structure by substitution of the N-alkyl group or the ring. Specific examples of p-phenylenediamine color developers include N,N-diethyl-2-methyl-p-phenylenediamine monohydrochloride (CD-2), N-ethyl-N-2-(methanesulfonylaminoethyl)-2-methyl-p-phenylenediamine sesquisulfate monohydrate (CD-3), and N-ethyl-N-2-(hydroxyethyl)-2-methyl-p-phenylenediamine sulfate (CD-4), listed here in the commonly used acid salt form.

Traditionally, photographic finishing solutions have consisted of multiple parts which are mixed by the photographic processor or photofinisher just prior to use. Multiple parts are often required in order to separate and preserve the chemical activity and solubility of components that may otherwise deteriorate or react with each other when they are stored together for long periods of time under alkaline conditions. For example, one part might include a color developing agent in the form of an acid salt of a p-phenylenediamine color developer, specific examples of which are listed above, typically in the form of a stabilized aqueous solution. These solutions are acidic since the color developer is formulated in this part as the acid salt.

Another part typically contains a base or combination of bases which, upon mixing of the parts, serves to neutralize the acid associated with the part containing the color developer and to establish the desired alkalinity of the mixed color developing composition. Another part may contain agents to preserve the alkalinity of the mixed color developing composition. Still another part may include an optical brightener. Upon combination of all parts and water, a homogeneous color developing composition can usually be obtained for the working strength solution in the processing machine.

Other function-specific materials listed above may be incorporated in these or other parts to provide a homogenous color developing composition of appropriate working strength in the processing machine. Because the resultant and desired pH of the complete, mixed photographic finishing solution is alkaline, typically having a pH of from 9-13, the active color developer in the final, fully mixed, photographic finishing composition is not the acid salt of the color developer, but the corresponding free base. The term “free base” refers to phenylenediamine compounds devoid, or essentially devoid, of acid addition salts of phenylenediamines.

It is generally known that the concentrations of various photographic chemicals used in a photographic processing bath must lie within certain narrow limits in order to provide optimal performance. The most important solvent for such photo processing is water. Most inorganic salts can be readily dissolved in water while the organic photo chemicals in such processing baths usually have suitable solubility in water at the desired operating concentrations.

For these reasons, photofinishers prefer to use a single photo finishing solution composition which contains a plurality of the parts formerly kept separate to avoid undesired reactions and/or decomposition. Moreover, there has been a desire in the industry to provide compositions that can be used right out of their containers without the need for mixing various components (thereby reducing mixing errors), such as in what are known as “automatic replenishing” processors. The use of such combined photo finishing solutions results in simplicity of operation with a reduction in the potential for mixing errors, poor photo processing results and user need not pay for transport or storage of large volumes of water.

The major incompatibility of the traditional parts of photo finishing solutions is between the acidic aqueous part, containing the acid salt of the color developer, and the alkaline part, containing the base or combination of bases. Since the active color developer in the final, mixed photo finishing composition is the free base form of the color developer, full consolidation of parts to produce a single-part formulation requires a source of p-phenylenediamine free base as the necessary ingredient.

Heretofore, p-phenylenediamine color developers in their free base form have not been available from the manufacturing segment of the industry. Accordingly, formulators have had to employ various procedures to produce the free bases from the corresponding p-phenylene acid salts. In preparing combined photo finishing solutions, formulators may form the p-phenylenediamine free base in situ as described in U.S. Pat. No. 5,273,865 from the p-phenylenediamine acid salt, leaving the neutralization products in the mixture. Alternatively, the p-phenylenediamine free base may be derived by neutralizing the corresponding acid salt followed by extraction into an organic solvent/water mixture, such as described in U.S. Pat. No. 6,017,687.

P-Phenylenediamine free bases are intermediates to the preparation of p-phenylenediamine color developer acid salts and are manufactured commercially as non-isolated intermediates by the reduction of the corresponding nitroso or nitro precursors in polar solvents such as low molecular weight alcohols or ethers. For example, U.S. Pat. No. 3,920,739 discloses the catalytic hydrogenation of the corresponding nitro precursor in water, methanol, ethanol, n- or iso-propanol, dioxane, or dipropyl ether over a variety of noble metal catalysts. After completion of the reaction, the catalyst is removed by filtration and the N,N-disubstituted-p-phenylenediamine is isolated by crystallization in the salt form by the addition of a mineral acid.

Japanese Patent Document JP 06-219997 discloses catalytic hydrogenation of the corresponding nitro compounds in ethanol over palladium-on-carbon catalyst, and isolation of the sulfate salts of the non-isolated free base intermediate.

Japanese Patent Document JP 52-144636 discloses catalytic hydrogenation in tetrahydrofuran over Raney nickel catalyst, and in dioxane over rhenium catalyst, and isolation of the sulfate salt of the non-isolated free intermediate.

Japanese Patent Document JP 57-007139 discloses catalytic hydrogenation in methanol over Raney nickel catalyst, and isolation of the sulfate salt of the non-isolated free base intermediate.

Methodologies for preparing p-phenylenediamine free base intermediates other than catalytic hydrogenation for the conversion of the corresponding nitroso or nitro intermediate to N,N-disubstituted p-phenylenediamines are also reported in the patent literature. For example, Japanese Patent Document JP 08-268978 discloses the reduction of nitroso precursors with hydrazine in water or isopropyl alcohol, and isolation of the mineral acid salt of the non-isolated free base intermediate.

The non-isolated free base subsequently is converted to the salt form by the addition of the appropriate acid and the salt is crystallized, isolated, and dried. The p-phenylene-diamine free bases are not isolated, in part, because of the susceptibility of these materials to oxidation, and must be handled with the rigorous exclusion of oxygen to prevent rapid and extensive discoloration. Consequently, handling of the free bases during manufacture of the p-phenylenediamine acid salts, in the absence of any preservative, demands an inert atmosphere. Once the free-base color developer is converted to the acid salt, the color developer is significantly more stable to oxygen exposure.

One or more preservatives, or antioxidants, are routinely incorporated into formulated photofinishing solutions. Such preservatives are well-known in the art and may be inorganic or organic materials. The specific preservative/antioxidant used will depend upon the formulation and application. Examples of typical preservatives/antioxidants include sodium sulfite, potassium sulfite, sodium bisulfite, potassium bisulfite, sodium metabisulfite, potassium metabisulfite, carbonyl-sulfite adducts, hydroxylamine and hydroxylamine derivatives, hydroxamic acids, hydrazines, hydrazides, aminoketones, phenols, amino acids, mono- and polysaccharides, mono-, di-, and polyamines, ascorbic acid and derivatives, erythrobic acid and derivatives, alcohols, oximes, and nitroxy radicals.

Solubilizing agents, or organic co-solvents, are typically incorporated into formulated photofinishing solutions to increase the solubility of the free-base form of the color developing agent. Fitness-for-use requirements for solubilizing agents, in addition to the requisite ability to solubilize p-phenylenediamine free base in the principally aqueous medium, include water solubility, low odor, and environmental acceptability. Examples of these solubilizing agents include alcohols, glycols, polyols, ketones, and N,N-dimethylformamide.

### SUMMARY OF THE INVENTION

Briefly, one aspect of the current invention is a p-phenylenediamine color developer composition wherein one embodiment is a stabilized color developer solution having: 1) from about 10 to 40 weight percent of a p-phenylenediamine free base color developer; 2) from about 40 to 70 weight percent of at least one photographically inactive water-miscible or water-soluble hydroxy-containing, organic solvent for the color developing agent in free base form; and 3) from about 1 to 40 weight percent of a preservative, antioxidant or mixture thereof for the p-phenylenediamine free base color developer; wherein the weight percentages are based on the total weight of the stabilized solution.

Another embodiment of the composition is a stabilized, solid p-phenylenediamine color developer composition useful in the preparation of compositions for the photographic finishing industry. The composition includes from about 50 to about 99 weight percent of a p-phenylenediamine free base color developer; and from about 1 to 50 weight percent of a preservative, antioxidant or combination thereof for the p-phenylenediamine free base color developer, wherein the weight percentages are based on the total weight of the composition.

Another aspect of the present invention is a process for preparing the stabilized p-phenylenediamine free base color developer compositions. In a first embodiment of the process, a stabilized p-phenylenediamine color developer solution is prepared by a direct hydrogenation process, which includes the steps of: 1) hydrogenating a nitro or nitroso precursor compound of the p-phenylenediamine free base color developer under hydrogenation conditions of pressure and temperature and in the presence of a heterogeneous, hydrogenation catalyst and at least one photographically inactive, water-miscible or water-soluble, hydroxy-containing, organic solvent of the color developing agent in free base form to obtain a mixture of the heterogeneous catalyst in a solution of p-phenylenediamine color developer free base and organic solvent; 2) separating the heterogeneous catalyst from the solution of p-phenylenediamine color developer free base and organic solvent; and 3) adding a preservative, antioxidant or combination thereof, for the p-phenylenediamine color developer free base to the solution obtained in step (2).

The color developing concentrate and method for its preparation offer a number of advantages over the photochemical compositions currently available or known. The present invention provides a means for the direct manufacture of a p-phenylenediamine color developer free base product solution which may be used directly by photochemical formulators without having to prepare the free base color developer from the respective acid salt. Direct manufacture of stable, color developer free base solutions from nitroso or nitro precursor compounds represents a significant improvement in the current technology used by formulators. Advantageously, performing the hydrogenation of step (1) in solvents compatible and useful in photographic developing solutions permits the direct and low cost manufacture of p-phenylenediamine free base solutions for supply to photochemical formulators. These solutions may be stabilized with one or more of a variety of antioxidants to provide protection from aerial oxidation.

In a second embodiment of the process of the present invention, a stabilized p-phenylenediamine free base color developer solution is prepared by: 1) hydrogenating a nitro or nitroso precursor compound of the p-phenylenediamine color developer free base in the presence of a hydrogenation catalyst and a first solvent selected from alkanols containing 1 to 6 carbon atoms, ethers containing 2 to 6 carbon atoms and mixtures thereof under hydrogenation conditions of pressure and temperature to obtain a first solution of p-phenylenediamine color developer free base; 2) separating the heterogeneous catalyst from the first solution of p-phenylenediamine color developer free base; 3) mixing a second solvent selected from at least one photographically inactive water-miscible or water-soluble, hydroxy-containing, organic solvent of the color developing agent in free base form with the first solution to obtain a second solution, and wherein the organic solvent has a boiling point at least 5° C. higher than the hydrogenation solvent used in step (1); 4) distilling the first solvent from the second solution; and 5) adding a preservative, antioxidant or combination thereof, for the p-phenylenediamine color developer free base to at least one of the solutions.

In a third embodiment of the process of the present invention, a stabilized p-phenylenediamine free base color developer solution is prepared by: 1) hydrogenating a nitro or nitroso precursor compound of the p-phenylenediamine color developer free base in the presence of a hydrogenation catalyst and a first solvent selected from alkanols containing 1 to 6 carbon atoms, ethers containing 2 to 6 carbon atoms and mixtures thereof under hydrogenation conditions of pressure and temperature to obtain a first solution of p-phenylenediamine color developer free base; 2) separating the heterogeneous catalyst from the first solution of p-phenylenediamine color developer free base; 3) crystallizing the p-phenylenediamine free base in the first solution; 4) recovering the crystallized p-phenylenediamine color developer; 5) dissolving the crystallized p-phenylenediamine color developer in a second solvent selected from at least one photographically inactive water-miscible or water-soluble, hydroxy-containing, organic solvent for the color developing agent in free base form to form a second solution; and 6) adding a preservative, antioxidant or combination thereof, for the p-phenylenediamine color developer free base to the second solution.

In a fourth embodiment of the process of the present invention, a stabilized, solid p-phenylenediamine free base color developer composition is prepared by: 1) hydrogenating a nitro or nitroso precursor compound of the p-phenylenediamine color developer free base in the presence of a hydrogenation catalyst and a solvent selected from alkanols containing 1 to 6 carbon atoms, ethers containing 2 to 6 carbon atoms and mixtures thereof under hydrogenation conditions of pressure and temperature to obtain a first solution of p-phenylenediamine color developer free base; 2) separating the heterogeneous catalyst from the solution of p-phenylenediamine color developer free base; 3) crystallizing the p-phenylenediamine free base in the solution; 4) recovering the crystallized p-phenylenediamine color developer; 5) adding a non-volatile preservative, antioxidant or combination thereof, to the recovered crystallized p-phenylenediamine color developer free base; and 6) drying the p-phenylenediamine color developer.

Surprisingly, it was discovered that formulating the chemicals in their concentrated free base form resulted in minimal loss in chemical stability of the p-phenylenediamine color developer free base, particularly when a preservative and/or an antioxidant was present. It has further been discovered that a free base solution can be directly prepared and packaged at a higher pH and maintain its stability.

### DETAILED DESCRIPTION OF THE INVENTION

In preparing the stabilized p-phenylenediamine color developer compositions of the present invention, the first step of the present invention involves the hydrogenation of a nitro or nitroso precursor compound of the p-phenylenediamine color developer free base in the presence of a solvent to obtain a solution of p-phenylenediamine free base. In accordance with the first process embodiment, the solvent is selected from a photographically inactive, water-soluble or water-miscible, hydroxy-containing organic solvent. The precursor compounds typically are 4-nitro-3-methyl-N,N-dialkylaniline compounds or 4-nitroso-3-methyl-N,N-dialkylaniline compounds wherein the alkyl groups are unsubstituted or substituted alkyl containing up to about 6 carbon atoms. The precursor compounds preferably are 4-nitroso (or nitro)-3-methyl-N,N-diethylaniline, 4-nitroso (or nitro)-3-methyl-N-ethyl-N-(2-methanesulfonamidoethyl)aniline and 4-nitroso (or nitro)-3-methyl-N-ethyl-N-(2-hydroxyethyl)aniline and mixtures thereof. Reduction of these precursor compounds produces the corresponding diamine compounds: 4-amino-3-methyl-N,N-diethylaniline (CD-2 free base), 4-amino-3-methyl-N-ethyl-N-(2-methanesulfonamidoethyl)aniline (CD-3 free base) and 4-amino-3-methyl-N-ethyl-N-(2-hydroxyethyl)aniline (CD-4 free base). Any reduction technology known in the art is suitable for this conversion. Preferably, the technology is catalytic hydrogenation under hydrogenation conditions of temperature and pressure using heterogeneous catalysis.

Typically, such hydrogenation techniques may be carried out at a temperature in the range of about 20° to 150° C., preferably about 35° to 70° C., and a total pressure in the range of about 0.3 to 103 bar gauge (barg) (approximately 5 to 1500 pounds per square inch—psig) preferably at a total pressure in the range of about 13.8 to 27.6 barg (approximately 200 to 400 psig).

The heterogeneous catalyst utilized in hydrogenating the nitro or nitroso precursor may be selected from a variety of known hydrogenation catalysts which are insoluble or substantially insoluble in the hydrogenation solvent. Examples of suitable catalysts include Raney nickel, Raney cobalt, platinum oxide, and palladium and platinum deposited on a catalyst support material, e.g., palladium-on-carbon, palladium-on-alumina, and platinum on alumina. The catalyst preferably is a supported palladium catalyst comprising about 1 to 5 weight percent palladium deposited on an alumina or carbon catalyst support. The amount of catalyst employed can vary significantly depending upon such factors as the particular catalyst and the hydrogenation conditions employed.

The photographically inactive, water-soluble or water-miscible, hydroxy-containing, organic solvent used in the hydrogenation step is preferably selected from solvents that are acceptable in photographic finishing (photofinishing) solutions. Formulated photofinishing solutions typically incorporate solubilizing agents, or organic co-solvents, to increase the solubility of the p-phenylenediamine free base color developing agent. Essential characteristics of the solvents which may be employed both in the hydrogenation step of our invention and in the formulation of photofinishing solutions include water solubility or miscibility, photographic inactivity, low odor, environmental friendliness and stability to the hydrogenation reaction, i.e., inertness. The suitable solvents also will have a relatively high solubility for the p-phenylenediamine color developer free base. Desirably, additional solvent characteristics include a flash point in excess of 37.8° C. (100° F.), low viscosity, and a melting point of less than 0° C. (32° F.). Examples of suitable hydrogenation solvents may be selected from alkanols containing 3 to 8 carbon atoms, such as 1-propanol, 2-propanol, 1-butanol, 2-butanol, 2-methyl-1-propanol, 1-pentanol, 2-pentanol, 3-methyl-1-butanol, and 3-methyl-2-butanol; glycols containing 2 to 8 carbon atoms, such as ethylene glycol, propylene glycol, 1,4-butanediol, 1,3-butanediol, 2-methyl-1,3-propanediol, 1,4-cyclohexanedimethanol, diethylene glycol, and triethylene glycol; polyethylene glycols, such as PEG-200, PEG-300, PEG-400, and PEG-600; glycol ethers containing 3 to 8 carbon atoms, such as 2-methoxyethanol, 2-ethoxyethanol, 2-propoxyethanol, 2-isopropoxyethanol, 2-butoxyethanol, 1-methoxy-2-propanol, 1-ethoxy-2-propanol, 3-methoxy-1-butanol, diethylene glycol monomethyl ether, diethylene glycol monoethyl ether, diethylene glycol mono-n-propyl ether, diethylene glycol mono-1-propyl ether, diethylene glycol monobutyl ether, and triethylene glycol monomethyl ether; dioxane; polyols such as glycerol; and polyol ethers containing 3 to 8 carbon atoms, such as 3-methoy-1,2-propanediol and 3-ethoxy-1,2-propanediol, and mixtures of these solvents. Preferably, the solvent employed in the hydrogenation step is selected from 2-propanol, 2-isopropoxyethanol, diethylene glycol, ethylene glycol, propylene glycol, PEG-200 and a mixture thereof.

The amount of solvent used may range from about 30 to 99 parts by weight, preferably about 60 to 75 parts by weight, per part by weight of precursor compound present. The stabilized solution of p-phenylenediamine free base color developer prepared in accordance with the present invention preferably contains about 10 to 40 weight percent, most preferably about 15 to 35 weight percent, p-phenylenediamine free base based on the total weight of the stabilized solution. If necessary, solvent may be added or removed, e.g., by vaporization under reduced pressure, to adjust the concentration of the p-phenylenediamine free base in the final, stabilized solution.

The concentration of the precursor nitroso or nitro compound in the hydrogenation solvent will dictate the concentration of the p-phenylenediamine free base color developer in the product solution. The workable concentration range of the precursor compound is from about 5 to 70 weight percent, the upper range being restricted by mass transfer considerations. In accordance with the present invention, the concentration of the nitroso or nitro precursor in the hydrogenation solvent preferably is about 10 to 50 weight percent, most preferably about 25 to 40 weight percent.

The product solution from the hydrogenation of the nitroso or nitro precursor invariably contains some amount of water since water is a by-product of the hydrogenation—one mole of water is produced for each mole of nitroso precursor hydrogenated and two moles of water are produced for each mole of nitro precursor hydrogenated. Furthermore, since the nitroso or nitro hydrogenation reactant typically is provided as a water-wet material, additional water is introduced into the hydrogenation and, consequently, into the product solution from the step (1) hydrogenation. For example, the water-wet, nitroso or nitro hydrogenation reactant may contain from about 10 to 30 weight percent water.

A preservative and/or antioxidant is added to the product solution. As used herein, the terms “preservative” and “antioxidant” are used interchangeably and are understood by one skilled in the photographic finishing art as a compound or composition that inhibits the degradation of the color developer composition. Examples of suitable preservatives or antioxidants include sodium sulfite, potassium sulfite, sodium bisulfite, potassium bisulfite, sodium metabisulfite, potassium metabisulfite, carbonyl-sulfite adducts, hydroxylamines, N,N-disubstituted hydroxylamines and hydroxylamine derivatives, hydroxamic acids, hydrazines, hydrazides, aminoketones, phenols, amino acids, mono- and polysaccharides, mono-, di-, and polyamines, ascorbic acid and derivatives, alcohols, oximes, and nitroxy radicals. Preferred preservatives are selected from N,N-dialkylhydroxylamine, such as N,N-diethylhydroxylamine, (DEHA); ascorbic acid, erythrobic acid; an alkali metal sulfite, such as sodium sulfite and potassium sulfite; and mixtures of any two or more thereof. The concentration of the preservative in the stabilized solution of p-phenylenediamine free base color developer depends upon such factors as the particular preservative/antioxidant employed and the concentration of the color developer in the stabilized solution. Normally the concentration of the preservative will be in the range of about 1 to 40 weight percent, preferably from about 1 to about 30 weight percent, and more preferably from about 2 to about 15 weight percent, based on the total weight of the stabilized solution.

The resulting stabilized solution of the first process embodiment includes: 1) from about 10 to 40 weight percent of a p-phenylenediamine free base color developer; 2) from about 40 to 70 weight percent of at least one photographically inactive water-miscible or water-soluble hydroxy-containing, organic solvent for the color developing agent in free base form; and 3) from about 1 to 40 weight percent of a preservative, antioxidant or mixture thereof for the p-phenylenediamine free base color developer, wherein the weight percentages are based on the total weight of the stabilized solution. Preferably, the stabilized solution includes: 1) from about 15 to 35 weight percent of a p-phenylenediamine free base color developer; 2) about 40 to 70 weight percent of at least one hydroxy-containing organic solvent for the p-phenylenediamine free base color developer; and 3) from about 1 to about 15 weight percent of a preservative, antioxidant or mixture thereof for the p-phenylenediamine free base color developer, wherein the weight percentages are based on the total weight of the stabilized solution.

In the second process embodiment of the present invention, the stabilized p-phenylenediamine free base color developer solution is prepared by: 1) hydrogenating a nitro or nitroso precursor compound of the p-phenylenediamine color developer free base in the presence of a hydrogenation catalyst and a first solvent selected from alkanols containing 1 to 6 carbon atoms, ethers containing 2 to 6 carbon atoms and mixtures thereof under hydrogenation conditions of pressure and temperature to obtain a first solution of p-phenylenediamine color developer free base. Except for the use of a different solvent, the step (1) hydrogenation of the second process embodiment is carried out in the same manner as described relative to the first embodiment above, i.e., using similar catalyst, hydrogenation conditions, amounts of materials, and the like. Suitable solvents utilized in the hydrogenation step of the process include methanol, ethanol, and tetrahydrofuran. Generally, such known hydrogenation solvents are not suitable for use in the preparation of photo finishing solutions because of flash points and/or environmental concerns. Alternatively, 1-propanol or 2-propanol may be used as the hydrogenation solvent. Advantageously, the propanols have a more favorable azeotrope with water than methanol, ethanol or tetrahydrofuran. Consequently, most of the water present in the hydrogenation product solution can be removed during the solvent exchange which is important to obtain maximum solubility of the free base since p-phenylenediamine free bases generally have poor solubility in water.

The second process embodiment further includes the steps of: 2) separating the heterogeneous catalyst from the first solution of p-phenylenediamine color developer free base; 3) mixing a second solvent selected from at least one photographically inactive, water-miscible or water-soluble, hydroxy-containing, organic solvent of the color developing agent in free base form with the first solution to obtain a second solution, and wherein the organic solvent has a boiling point at least 5° C. higher than the hydrogenation solvent used; 4) distilling the first solvent from the second solution; and 5) adding a preservative, antioxidant or combination thereof, for the p-phenylenediamine color developer free base to at least one of the solutions.

Separating the heterogeneous catalyst from the first solution of p-phenylenediamine color developer free base can be achieved using conventional separation techniques, such as filtering or centrifuging. A heat-stable preservative may be added at this point.

After mixing the photographically inactive, water-miscible or water-soluble, hydroxy-containing, organic solvent to form a second solution, the mixture then is heated to vaporize or distill the C₁-C₆ alkanol or C₂-C₆ ether hydrogenation solvent from the second solution. The amount of C₁-C₆ alkanol or C₂-C₆ ether solvent removed from the second solution should be at least 50 weight percent, preferably from about 90 to 98 weight percent, of the amount of solvent present in the second solution. Sufficient photographically inactive, water-soluble, hydroxy-containing, organic solvent and preservative, antioxidant or mixture thereof for the p-phenylenediamine free base color developer is added to produce a stabilized solution of p-phenylenediamine free base color developer containing: 1) about 10 to 40 weight percent, most preferably about 15 to 35 weight percent, p-phenylenediamine free base; 2) from about 40 to 70 weight percent of at least one photographically inactive water-miscible or water-soluble hydroxy-containing, organic solvent for the color developing agent in free base form; and 3) from about 1 to 40 weight percent of a preservative, antioxidant or mixture thereof for the p-phenylenediamine free base color developer; wherein the weight percentages are based on the total weight of the stabilized solution.

The preservative, antioxidant or combination thereof, for the p-phenylenediamine color developer free base may be added at any point in the process subsequent to the completion of the reduction or hydrogenation step, i.e., to at least one of the solutions. The final stabilized solution composition may further be subjected to carbon treatment to reduce coloration of the final product solution.

In the third embodiment of the process of the present invention, a stabilized p-phenylenediamine free base color developer solution is prepared by: 1) hydrogenating a nitro or nitroso precursor compound of the p-phenylenediamine color developer free base in the presence of a hydrogenation catalyst and a first solvent selected from alkanols containing 1 to 6 carbon atoms, ethers containing 2 to 6 carbon atoms and mixtures thereof under hydrogenation conditions of pressure and temperature to obtain a first solution of p-phenylenediamine color developer free base; 2) separating the heterogeneous catalyst from the first solution of p-phenylenediamine color developer free base; 3) crystallizing the p-phenylenediamine free base in the first solution; 4) recovering the crystallized p-phenylenediamine free base color developer; 5) dissolving the crystallized p-phenylenediamine free base color developer in at least one photographically inactive water-miscible or water-soluble, hydroxy-containing, organic solvent for the color developing agent in free base form to form a second solution; and 6) adding a preservative, antioxidant or combination thereof, for the p-phenylenediamine color developer free base to the second solution.

As described above for the second process embodiment, the hydrogenation step of the third process embodiment is carried out using similar catalyst, hydrogenation conditions, amounts of materials, and the like to produce a first solution. Alternatively and preferably, the hydrogenation is carried out using 2-propanol as the reaction solvent p-Phenylenediamine free base color developers have lower solubility in 2-propanol which results in greater product recovery.

Similarly, the heterogeneous catalyst is separated or removed from the first solution of p-phenylenediamine color developer free base using conventional separation techniques such as filtering and centrifuging.

After separating the heterogeneous catalyst from the first solution, the first solution is cooled to crystallize the p-phenylenediamine free base. The crystallized material may be recovered or isolated by conventional liquid-solid separation techniques such as filtration and centrifugation. Crystallization of the p-phenylenediamine color developer is carried out using conventional methods known to those skilled in the crystallization and purification art.

The recovered crystallized p-phenylenediamine free base is then dissolved in a sufficient quantity of photographically inactive water-miscible or water-soluble, hydroxy-containing, organic solvent for the color developing agent in free base form to form a second solution. To the second solution a preservative, antioxidant or mixture thereof for the p-phenylenediamine free base color developer is added to produce a stabilized solution of p-phenylenediamine free base color developer containing: 1) about 10 to 40 weight percent, most preferably about 15 to 35 weight percent, p-phenylenediamine free base; 2) from about 40 to 70 weight percent of at least one photographically inactive water-miscible or water-soluble hydroxy-containing, organic solvent for the color developing agent in free base form; and 3) from about 1 to 40 weight percent of a preservative, antioxidant or mixture thereof for the p-phenylenediamine free base color developer; wherein the weight percentages are based on the total weight of the stabilized solution.

The stabilized solution of the p-phenylenediamine color developers prepared by the above processes may further include up to about 25 weight percent water, and desirably from about 4 to 12 weight percent water, and more desirably less than about 10 weight percent water.

The p-phenylenediamine free base crystallized and separated from the crude hydrogenation product solution may be used solvent wet or may be dried in an inert atmosphere, i.e., in the absence of air or other oxygen-containing gas, optionally using an in-process preservative. The final dry product may be dissolved in an appropriate solvent or solvent combination with or without stabilization, or may itself be provided to the photofinishing industry as a dry, solid product.

In the fourth embodiment of the process of the present invention, a stabilized solid p-phenylenediamine free base color developer composition is prepared by: 1) hydrogenating a nitro or nitroso precursor compound of the p-phenylenediamine color developer free base; 2) separating the heterogeneous catalyst from the solution of p-phenylenediamine color developer free base and solvent; 3) crystallizing the p-phenylenediamine free base in the solution; and 4) recovering the crystallized p-phenylenediamine color developer. The steps (1)-(4) are carried out in a similar manner to the similar steps described above for the third embodiment of the process. The fourth embodiment further includes the steps of 5) adding a non-volatile preservative, antioxidant or combination thereof, to the recovered crystallized p-phenylenediamine color developer free base; and 6) drying the p-phenylenediamine color developer in the presence of the non-volatile preservative, antioxidant or combination thereof. Suitable heat-stable, non-volatile preservatives or antioxidants which may be present in the dry material include sodium sulfite, potassium sulfite, sodium bisulfite, potassium bisulfite, sodium metabisulfite and potassium bisulfite.

The drying of the solvent-wet color developer free base may be carried out in any general and standard equipment known to the industry. The isolation and drying of the color developer free base preferably is performed in an autofilter dryer wherein the isolated, solvent-wet color developer free base may be maintained in an inert atmosphere from crystallization through drying.

The p-phenylenediamine color developer product is a stabilized, solid composition containing from about 50 to 99 weight percent of a p-phenylenediamine free base color developer and from about 1 to 50 weight percent of a preservative, antioxidant or combination thereof, wherein the weight percentages are based on the total weight of the stabilized p-phenylenediamine free base composition. Preferably, the stabilized, solid composition contains from about 1 to about 20 weight percent, and more preferably from about 2 to about 5 weight percent of a preservative, antioxidant or combination thereof, and essentially the remainder of the composition comprising the p-phenylenediamine color developer.

The present invention is illustrated in greater detail by the specific examples presented below. It is to be understood that these examples are illustrative embodiments and are not intended to be limiting of the invention, but rather are to be construed broadly within the scope and content of the appended claims. The percentages given in the examples are by weight unless specified otherwise.

### EXAMPLES

### Solubility of p-Phenylenediamine Free Base

The solubility of the free base form of color developers CD-3 and CD-4 in a number of potential solvents was determined. The free base form of the color developer CD-2 is a liquid at room temperature and fully miscible in all solvents evaluated. Representative solvents were selected from each of the different classes of solvents: alcohols, glycols and glycol ethers. A small quantity of a representative preservative, 3% of N,N-dietheylhydroxylamine (DEHA), was added. Excess dry color developer free base (CD-3 and CD-4) was added to each solvent and saturation was achieved by mixing for several hours at room temperature. The saturation concentration in weight percent was determined by the techniques of both high pressure liquid chromatography (HPLC) and nuclear magnetic resonance (NMR), the results from each analytical method being quite comparable. CD-4 free base was found to be highly soluble in all the solvents evaluated, whereas CD-3 free base was found to have lesser solubility. Table I shows the saturation solubility of CD-3 free base (Examples 1-18) and CD-4 free base (Examples 19-24) at ambient temperature using a variety of solvents and solvent/water mixtures. In Table I, Solvent:Water refers to the weight:weight, solvent:water ratio when water was included, CD Free Base Concentration refers to the weight percent saturation concentration of CD-3 or CD-4 free base, and PEG 200 and PEG 300 refers to poly(ethylene glycol) having an average molecular weight of 200 or 300.

TABLE I

| Example | | | CD Free Base |
|---|---|---|---|
| No. | Solvent | Solvent:Water | Conc. |
| 1 | 2-Isopropoxyethanol | — | 8.6 |
| 2 | 2-Methyl-1,3-Propanediol | — | 3.3 |
| 3 | 3-Methoxy-1-Butanol | — | 9.3 |
| 4 | PEG-200 | — | 16.9 |
| 5 | PEG-300 | — | 16.7 |
| 6 | Diethylene Glycol | — | 15.2 |
| 7 | Methanol | — | 23.6 |
| 8 | Methanol/Water | 90:10 | 18.9 |
| 9 | Methanol/Water | 50:50 | 6.8 |
| 10 | Methanol/Water | 10:90 | 0.7 |
| 11 | Ethanol | — | 5.4 |
| 12 | Ethanol/Water | 90:10 | 9.7 |
| 13 | Ethanol/Water | 50:50 | 9.0 |
| 14 | Ethanol/Water | 10:90 | 0.6 |
| 15 | 2-Propanol | — | 1.8 |
| 16 | 2-Propanol/Water | 90:10 | 7.8 |
| 17 | 2-Propanol/Water | 50:50 | 9.2 |
| 18 | 2-Propanol/Water | 10:90 | 0.8 |
| 19 | 2-Isopropoxyethanol | — | 32.6 |
| 20 | 2-Methyl-1,3-Propanediol | — | 33.2 |
| 21 | 3-Methoxy-1-Butanol | — | 35.5 |
| 22 | PEG-200 | — | 31.0 |
| 23 | PEG-300 | — | 28.3 |
| 24 | Diethylene Glycol | — | 38.4 |

### Preparation of the Free Base of p-Phenylenediamine Color Developers

The nitroso precursors of CD-2 free base, CD-3 free base and CD-4 free base, i.e., 4-nitroso-3-methyl-N,N-diethylaniline, 4-nitroso-3-methyl-N-ethyl-N-(2-methanesulfonamidoethyl)aniline and 4-nitroso-3-methyl-N-ethyl-N-(2-hydroxyethyl)aniline, were hydrogenated in a variety of solvents. Each hydrogenation was performed in a Paar 300 ml autoclave with a single-speed, hollow-shaft impeller having an inlet at the top. This allowed mixing of the gases in the head space with reaction liquid. Hydrogen was fed to the autoclave through a dip tube that extended to the bottom. At completion of the reaction, the dip tube was used to drain the reaction mixture through a heated in-line filter and into a nitrogen-purged, three-neck, receiving flask. This eliminated exposure of the product to oxygen. The autoclave also contained a thermocouple and cooling coil along with an opening in the head for depressurization, all surrounded by an electric heating mantle.

The autoclave was charged with 110.5 ml of solvent, (as indicated in Table I below), 58.0 g (dry weight basis) of nitroso or nitro precursor compound, and 0.59 g of 5% palladium-on-alumina catalyst. The nitroso or nitro precursor compound is used water-wet, nominally 90% solids. The impeller was started and the autoclave was purged 3 times with nitrogen and then purged 3 times with 10.3 barg (150 psig) hydrogen. The autoclave then was pressurized to 10.3 barg (150 psig) with hydrogen and then heated to 35° C. to initiate reaction. Hydrogenation was carried out until hydrogen uptake ceased. The autoclave was maintained at the final temperature and pressure for 1 additional hour. The temperature and pressure were then increased to 65° C. and 34.5 barg (500 psig) and maintained for 1 additional hour after hydrogen uptake ceases. The temperature of the autoclave was lowered to 50° C. and vented. The autoclave was then purged 3 times with nitrogen. The hydrogenation product solution was discharged to a receiver flask optionally containing a preservation or combination of preservatives.

Using the general procedure described above, 4-nitroso-3-methyl-N-ethyl-N-(2-methanesulfonamidoethyl)aniline (CD-3 Nitroso) was catalytically hydrogenated using the solvents, temperatures (Temp ° C.), pressures (Press psig), and times (Time, minutes) set forth in Table II to produce solutions of CD-3 free base. CHDM-90 is a mixture consisting of 90% 1,4-cyclohexanedimethanol and 10% water.

TABLE II

| Example | | Temp. | Pressure | Time |
|---|---|---|---|---|
| No. | Solvent | (° C.) | (psig) | (min) |
| 25 | 2-Propanol | 35 | 150 | 150 |
| 26 | 2-Propanol | 35 | 150 | 150 |
| 27 | 2-Propanol | 35 | 150 | 150 |
| 28 | 2-Propanol | 35 | 150 | 150 |
| 29 | 2-Methyl-1,3-Propanediol | 65 | 150 | 150 |
| 30 | 2-Isopropxyethanol | 35 | 270 | 300 |
| 31 | 3-Methoxy-1-Butanol | 35 | 150 | 90 |
| 32 | Diethylene Glycol | 65 | 500 | 330 |
| 33 | PEG-300 | 65 | 500 | 330 |
| 34 | 2-Propanol | 35 | 150 | 270 |
| 35 | 2-Isopropoxyethanol | 65 | 500 | 900 |
| 36 | 2-Isopropoxyethanol | 35 | 150 | 330 |
| 37 | CHDM-90 | 65 | 500 | 390 |
| 38 | 2-Isopropoxyethanol | 35 | 500 | 330 |
| 39 | PEG-200 | 65 | 500 | 300 |
| 39 | Diethylene Glycol | 35 | 150 | 360 |
| 40 | 2-Isopropoxyethanol | 35 | 150 | 315 |
| 41 | 2-Isopropoxyethanol | 35 | 150 | 333 |
| 42 | 2-Isopropoxyethanol | 35 | 150 | 324 |
| 43 | PEG-200 | 58 | 250 | 309 |
| 44 | 50/50 PEG-200/2-Propanol | 58 | 500 | 300 |

Using the general procedure described above, 4-nitroso-3-methyl-N-ethyl-N-(2-hydroxyethyl)aniline (CD-4 Nitroso) was catalytically hydrogenated using the solvents, temperatures (Temp, ° C.), pressures (Press psig), and times (Time, minutes) set forth in Table III below to produce solutions of CD-4 free base.

TABLE III

| Example | | Temp. | Pressure | Time |
|---|---|---|---|---|
| No. | Solvent | (° C.) | (psig) | (min) |
| 45 | 2-Isopropoxyethanol | 35 | 150 | 300 |
| 46 | PEG-200 | 64 | 500 | 319 |
| 47 | Diethylene Glycol | 64 | 500 | 307 |
| 48 | 2-Isopropoxyethanol | 35 | 150 | 290 |

The examples of Tables II and III illustrate the use of representative alcohol, glycol, glycol ether, and polyol solvents. Each solvent produced satisfactory results for the catalytic hydrogenation with some modification in the hydrogenation conditions. The loading of the nitroso precursor compound is such that the solution of the color developer free base resulting from the hydrogenation generally is 30 to 40%, depending primarily upon the density of the solvent. The product solution is clarified to remove any catalyst, and discharged into a flask containing a preservative. Preservatives utilized include DEHA, ascorbic acid, and sodium sulfite in amounts which gave a stabilized color developer free base containing 1 to 40 weight percent, preferably 1 to 30 weight percent, and most preferably from 2 to 15 weight percent, of the preservative.

Since the solubility data of Table I show that the saturation concentration of the p-phenylenediamine free base color developer generally is less than the concentration of the product solution exiting the autoclave, the receiving flask usually was charged with additional solvent to maintain a solution after cooling to ambient temperature. PEG-200 was utilized in some examples, as well as water and caustic. Many of these free base solutions also were treated with activated carbon to reduce the final solution color.

The following examples illustrate the embodiment of the process of the present invention wherein a nitro or nitroso precursor is hydrogenated in the presence of a C₁ to C₆ alkanol and/or a C₂ to C₆ ether solvent and then the solvent is exchanged after hydrogenation to a solvent or solvent combination compatible and useful in photographic formulations. This embodiment comprises removing the hydrogenation solvent by distillation, with or without reduced pressure, and then replacing that solvent with a water-soluble, hydroxy-containing, organic solvent which is suitable for use in the preparation of photofinishing solutions.

### EXAMPLE 49

A 425 gram autoclave solution containing 23.2% CD-3 free base, 2.5% DEHA in 268 g of 2-propanol, and 47 g of water was added to a two-liter flask equipped with an overhead agitator, temperature probe, addition funnel, condenser with take-off provision, and nitrogen blanketing. PEG-200, 326.4 g, was added to the flask. The mixture was distilled at a vapor temperature of approximately 85° C. 276.8 g. of distillate were removed up to a pot temperature of 120° C. The amber-colored solution was cooled to ambient temperature, and 5.7 g. of activated carbon was added. The mixture was heated to 70° C., and stirred for three hours. The solution was clarified at 70° C. to remove the carbon, and cooled to room temperature. The final amber solution contained nominally 20% CD-3 free base, and remained in solution at ambient temperature.

Although the hydrogenation of the nitroso (or nitro) precursor was carried out in 2-propanol, methanol or ethanol are satisfactory substitutes. The product solution of the color developer free base is clarified into a distillation flask which may contain an antioxidant or preservative. After the solvent exchange is complete, the solution may optionally be treated with activated carbon to reduce color. The results clearly demonstrate the utility of the process technology for the manufacture of Color Developer Free Base solutions.

In the third embodiment of the process, the nitro or nitroso precursor is hydrogenated under conditions previously described and the color developer free base is isolated by crystallization and separation from the autoclave solution after removal of the heterogeneous hydrogenation catalyst. This embodiment is useful only for those color developers which in their free base forms are solids at ambient temperature, e.g., the free base forms of CD-3 and CD-4. This embodiment does not apply to color developers which in their free base forms are liquids at ambient temperature, e.g., the free base form of CD-2. The hydrogenation solvent preferably is 2-propanol. The solubility data reported in Table I for CD-3 free base illustrate the superiority of 2-propanol, since CD-3 free base exhibits low solubility in and highest product recovery from 2-propanol. The crystallization process is illustrated by Examples 50 and 51.

### EXAMPLE 50

A 1264 g autoclave solution containing 23.9% CD-3 free base (296 g), 1.9% DEHA (24 g) in 802 g of 2-propanol, and 142 g water was added to a two-liter flask equipped with an overhead agitator, temperature probe, and nitrogen blanketing. The solution was cooled to 23° C. to crystallize the CD-3 free base. The CD-3 free base was collected by filtration at 23° C. and dried to give 191.2 g CD-3 free base having a purity of 98.2%. The filtrate was further cooled to 2° C. to isolate additional CD-3 free base which was collected by filtration at 23° C. and dried to give an additional 61.2 g of CD-3 free base. The total recovery of CD-3 free base is 85.3%.

### EXAMPLE 51

A 450 g autoclave solution containing 21.1% CD-3 free base (89 g), 2.4% DEHA (10 g) in 273 g of 2-propanol, and 48 g water was added to a one-liter flask equipped with an overhead agitator, temperature probe, and nitrogen blanketing. The solution was cooled to 2° C. to crystallize the CD-3 free base. The CD-3 free base was collected by filtration at 2° C. and dried to give 78 g CD-3 free base having a purity of 98.2% by HPLC area percent, providing a recovery of CD-3 free base of 87.6%.

The product from Examples 50 and 51 was dried to determine the recovery rate accurately. Dissolution of the isolated, solvent-wet solids, typically about 80 to 90 weight percent solids, in any solvent suitable for use in the preparation of photofinishing solutions is easily and simply effected. This dissolution is accompanied with the addition of a suitable preservative or combination of preservatives.

The color developer free base which has been crystallized and isolated as a solvent-wet solid as described above may be dried to produce the dry, solid composition constituting one of the embodiments of the present invention. Because of the propensity of color developer free bases to oxidize upon exposure to air, stabilization by the addition of a preservative or combination of preservatives is desirable. Any of the preservatives known to the industry and described above are suitable for stabilization. The preservative preferably is a solid at room temperature and, most preferably, is an inorganic sulfite, bisulfite or metabisulfite. The drying of the solvent-wet color developer free base preferably is carried out in the presence of the preservative. Adding the preservative(s) to the drier with the solvent-wet color developer free base insures a fine and even distribution of the preservative throughout the dried material.

The resulting dried and stabilized free base composition is novel and represents a significant improvement in providing color developer free bases to the photofinishing industry. Alternatively, the dried material may be dissolved in any suitable solvent herein described for delivery to the photofinishing industry.

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

1. A stabilized solution of a p-phenylenediamine free base color developer comprising:
a. about 10 to 40 weight percent of a p-phenylenediamine free base color developer selected from the group consisting of N,N-diethyl-2-methyl-p-phenylenediamine, N-ethyl-N-2-(methanesulfonylaminoethyl)-2-methyl-p-phenylenediamine, N-ethyl-N-2-(hydroxyethyl)-2-methyl-p-phenylenediamine and mixtures thereof;
b. about 40 to 70 weight percent of at least one hydroxy-containing organic solvent for the p-phenylenediamine free base color developer; and
c. about 1 to 40 weight percent of a p-phenylenediamine free base color developer preservative, and wherein the weight percentages are based on the total weight of the stabilized solution.

2. The stabilized solution of claim 1 wherein said hydroxy-containing organic solvent is selected from the group consisting of 1-propanol, 2-propanol, 1-butanol, 2-butanol, 2-methyl-1-propanol, 1-pentanol, 2-pentanol, 3-methyl-1-butanol, and 3-methyl-2-butanol, ethylene glycol, propylene glycol, 1,4-butanediol, 1,3-butanediol, 2-methyl-1,3-propanediol, 1,4-cyclohexanedimethanol, diethylene glycol, triethylene glycol, polyethylene glycol selected from the group consisting of PEG-200, PEG-300, PEG-400, and PEG-600; 2-methoxyethanol, 2-ethoxyethanol, 2-propoxyethanol, 2-isopropoxyethanol, 2-butoxyethanol, 1-methoxy-2-propanol, 1-ethoxy-2-propanol, 3-methoxy-1-butanol, diethylene glycol monomethyl ether, diethylene glycol monoethyl ether, diethylene glycol mono-n-propyl ether, diethylene glycol mono-1-propyl ether, diethylene glycol monobutyl ether, triethylene glycol monomethyl ether, dioxane, glycerol, 3-methoy-1,2-propanediol, 3-ethoxy-1,2-propanediol, and mixtures of these solvents.

3. The stabilized solution of claim 1 wherein said hydroxy-containing organic solvent is selected from the group consisting of 2-propanol, 2-isopropoxyethanol, diethylene glycol, ethylene glycol, propylene glycol, PEG-200 and mixtures of these solvents.

4. The stabilized solution of claim 1 wherein said solution comprises from about 15 to 35 weight percent, p-phenylenediamine free base based on the total weight of the stabilized solution.

5. The stabilized solution of claim 1 wherein said solution comprises from about 1 to about 30 weight percent of a preservative.

6. The stabilized solution of claim 1 wherein said solution comprises from about 2 to about 15 weight percent of a preservative.

7. The stabilized solution of claim 1 wherein said preservative is selected from the group consisting of sodium sulfite, potassium sulfite, sodium bisulfite, potassium bisulfite, sodium metabisulfite, potassium metabisulfite, carbonyl-sulfite adducts, hydroxylamines, N,N-disubstituted hydroxylamines, hydroxamic acids, hydrazines, hydrazides, aminoketones, phenols, amino acids, mono- and polysaccharides, mono-, di-, and polyamines, ascorbic acid, alcohols, oximes, nitroxy radicals and mixtures of these preservatives.

8. The stabilized solution of claim 7 wherein said preservative is selected from the group consisting of N,N-dialkylhydroxylamine, N,N-diethylhydroxylamine, ascorbic acid, erythrobic acid, sodium sulfite, potassium sulfite, and mixtures of these preservatives.

9. The stabilized solution of claim 1 further comprising from about 4 to 12 weight percent water.

10. A stabilized solution of a p-phenylenediamine free base color developer comprising:
a. about 15 to 35 weight percent of a p-phenylenediamine free base color developer selected from the group consisting of N,N-diethyl-2-methyl-p-phenylenediamine, N-ethyl-N-2-(methanesulfonylaminoethyl)-2-methyl-p-phenylenediamine, N-ethyl-N-2-(hydroxyethyl)-2-methyl-p-phenylenediamine and mixtures thereof;
b. about 40 to 70 weight percent of at least one hydroxy-containing organic solvent for the p-phenylenediamine free base color developer selected from the group consisting of 2-propanol, 2-isopropoxyethanol, diethylene glycol, ethylene glycol, propylene glycol, PEG-200 and mixtures of these solvents; and
c. about 1 to 40 weight percent of a p-phenylenediamine free base color developer preservative selected from the group consisting of N,N-diethylhydroxyl-amine, ascorbic acid, erythrobic acid, sodium sulfite, potassium sulfite, and mixtures of these preservatives, and wherein the weight percentages are based on the total weight of the stabilized solution.

11. A stabilized solution of a p-phenylenediamine free base color developer consisting essentially of:
a. about 10 to 40 weight percent of a p-phenylenediamine free base color developer selected from the group consisting of N,N-diethyl-2-methyl-p-phenylenediamine, N-ethyl-N-2-(methanesulfonylaminoethyl)-2-methyl-p-phenylenediamine, N-ethyl-N-2-(hydroxyethyl)-2-methyl-p-phenylenediamine and mixtures thereof;
b. about 40 to 70 weight percent of at least one hydroxy-containing organic solvent for the p-phenylenediamine free base color developer; and
c. about 1 to 40 weight percent of a p-phenylenediamine free base color developer preservative, and wherein the weight percentages are based on the total weight of the stabilized solution.

12. The stabilized solution of claim 11 wherein said hydroxy-containing organic solvent is selected from the group consisting of 2-propanol, 2-isopropoxyethanol, diethylene glycol, ethylene glycol, propylene glycol, PEG-200 and mixtures of these solvents.

13. The stabilized solution of claim 11 wherein said solution comprises from about 15 to 3.5 weight percent, p-phenylenediamine free base based on the total weight of the stabilized solution.

14. The stabilized solution of claim 11 wherein said preservative is selected from the group consisting of N,N-dialkylhydroxylamine, N,N-diethylhydroxylamine, ascorbic acid, erythrobic acid, sodium sulfite, potassium sulfite, and mixtures of these preservatives.

15. A solid, stabilized p-phenylenediamine free base composition comprising:
a. from 50 to about 99 weight percent of a p-phenylenediamine free base color developer; and
b. from about 1 to 50 weight percent of a p-phenylenediamine free base color developer preservative, and wherein the weight percentages are based on the total weight of the solid, stabilized p-phenylenediamine free base composition.

16. The solid, stabilized composition of claim 15 wherein said p-phenylenediamine free base color developer is from about 80 to 99 weight % and said preservative is from about 1 to 20 weight % of the composition.

17. The solid, stabilized composition of claim 15 wherein said p-phenylenediamine free base color developer is selected from the group consisting of N-ethyl-N-2-(methanesulfonylaminoethyl)-2-methyl-p-phenylenediamine, N-ethyl-N-2-(hydroxyethyl)-2-methyl-p-phenylenediamine and mixtures thereof.

18. The stabilized solution of claim 15 wherein said preservative is selected from the group consisting of sodium sulfite, potassium sulfite, sodium bisulfite, potassium bisulfite, sodium metabisulfite, potassium metabisulfite, carbonyl-sulfite adducts, hydroxylamines, N,N-disubstituted hydroxylamines, hydroxamic acids, hydrazines, hydrazides, aminoketones, phenols, amino acids, mono- and polysaccharides, mono-, di-, and polyamines, ascorbic acid, alcohols, oximes, nitroxy radicals and mixtures of these preservatives.

19. The stabilized solution of claim 15 wherein said preservative is selected from the group consisting of N,N-dialkylhydroxylamine, N,N-diethylhydroxylamine, ascorbic acid, erythrobic acid, sodium sulfite, potassium sulfite, and mixtures of these preservatives.

20. A process for preparing a stabilized solution of a p-phenylenediamine free base color developer which comprises the steps of:
a. hydrogenating a nitro or nitroso precursor compound of the p-phenylenediamine free base color developer under hydrogenation conditions of pressure and temperature and in the presence of a heterogeneous, hydrogenation catalyst and at least one photographically inactive, water-miscible or water-soluble, hydroxy-containing, organic solvent of the color developing agent in free base form to obtain a mixture of the heterogeneous catalyst in a solution of p-phenylenediamine color developer free base and organic solvent;
b. separating the heterogeneous catalyst from the solution of p-phenylenediamine color developer free base and organic solvent; and
c. adding a p-phenylenediamine color developer free base preservative to the solution obtained in step (b).

21. The process of claim 20 wherein said precursor is selected from the group consisting of 4-nitroso or nitro-3-methyl-N,N-diethylaniline, 4-nitroso or nitro-3-methyl-N-ethyl-N-(2-methanesulfonamidoethyl)aniline, 4-nitroso or nitro-3-methyl-N-ethyl-N-(2-hydroxyethyl)aniline and mixtures thereof.

22. The process of claim 20 wherein said precursor is selected from the group consisting of 4-nitroso-3-methyl-N,N-diethylaniline, 4-nitroso-3-methyl-N-ethyl-N-(2-methanesulfonamidoethyl)aniline or 4-nitroso-3-methyl-N-ethyl-N-(2-hydroxyethyl)aniline.

23. The process of claim 20 wherein said hydroxy-containing organic solvent is selected from the group consisting of 1-propanol, 2-propanol, 1-butanol, 2-butanol, 2-methyl-1-propanol, 1-pentanol, 2-pentanol, 3-methyl-1-butanol, and 3-methyl-2-butanol, ethylene glycol, propylene glycol, 1,4-butanediol, 1,3-butanediol, 2-methyl-1,3-propanediol, 1,4-cyclohexanedimethanol, diethylene glycol, triethylene glycol, polyethylene glycol selected from the group consisting of PEG-200, PEG-300, PEG-400, and PEG-600; 2-methoxyethanol, 2-ethoxyethanol, 2-propoxyethanol, 2-isopropoxyethanol, 2-butoxyethanol, 1-methoxy-2-propanol, 1-ethoxy-2-propanol, 3-methoxy-1-butanol, diethylene glycol monomethyl ether, diethylene glycol monoethyl ether, diethylene glycol mono-n-propyl ether, diethylene glycol mono-1-propyl ether, diethylene glycol monobutyl ether, triethylene glycol monomethyl ether, dioxane, glycerol, 3-methoy-1,2-propanediol, 3-ethoxy-1,2-propanediol, and mixtures of these solvents.

24. The stabilized solution of claim 23 wherein said hydroxy-containing organic solvent is selected from the group consisting of 2-propanol, 2-isopropoxyethanol, diethylene glycol, ethylene glycol, propylene glycol, PEG-200 and mixtures of these solvents.

25. The stabilized solution of claim 23 wherein said preservative is selected from the group consisting of sodium sulfite, potassium sulfite, sodium bisulfite, potassium bisulfite, sodium metabisulfite, potassium metabisulfite, carbonyl-sulfite adducts, hydroxylamines, N,N-disubstituted hydroxylamines, hydroxamic acids, hydrazines, hydrazides, aminoketones, phenols, amino acids, mono- and polysaccharides, mono-, di-, and polyamines, ascorbic acid, alcohols, oximes, nitroxy radicals and mixtures of these preservatives.

26. A process for preparing a stabilized solution of a p-phenylenediamine free base color developer which comprises the steps of:
a. hydrogenating a nitro or nitroso precursor compound of the p-phenylenediamine color developer free base in the presence of a hydrogenation catalyst and a first solvent selected from the group consisting of alkanols containing 1 to 6 carbon atoms, ethers containing 2 to 6 carbon atoms and mixtures thereof and under hydrogenation conditions of pressure and temperature to obtain a first solution of p-phenylenediamine color developer free base;
b. separating the heterogeneous catalyst from the first solution of p-phenylenediamine color developer free base;
c. mixing a second solvent selected from at least one photographically inactive water-miscible or water-soluble, hydroxy-containing, organic solvent of the color developing agent in free base form with the first solution to obtain a second solution, and wherein the organic solvent has a boiling point at least 5° C. higher than the first solvent;
d. distilling said first solvent from the second solution; and
e. adding a p-phenylenediamine color developer free base preservative to at least one of the solutions.

27. The process of claim 26 wherein said precursor compound is selected from the group consisting of 4-nitroso-3-methyl-N,N-diethylaniline, 4-nitroso-3-methyl-N-ethyl-N-(2-methanesulfonamidoethyl)aniline, 4-nitroso-3-methyl-N-ethyl-N-(2-hydroxyethyl)aniline and mixtures thereof, and said p-phenylenediamine color developer free base is selected from the group consisting of N,N-diethyl-2-methyl-p-phenylenediamine, N-ethyl-N-2-(methanesulfonylaminoethyl)-2-methyl-p-phenylenediamine, N-ethyl-N-2-(hydroxyethyl)-2-methyl-p-phenylenediamine and mixtures thereof.

28. The process of claim 26 wherein said first solvent is selected from the group consisting of methanol, ethanol, tetrahydrofuran, 1-propanol, 2-propanol and mixtures thereof.

29. The process of claim 26 wherein said second solvent is selected from the group consisting of 1-propanol, 2-propanol, 1-butanol, 2-butanol, 2-methyl-1-propanol, 1-pentanol, 2-pentanol, 3-methyl-1-butanol, and 3-methyl-2-butanol, ethylene glycol, propylene glycol, 1,4-butanediol, 1,3-butanediol, 2-methyl-1,3-propanediol, 1,4-cyclohexanedimethanol, diethylene glycol, triethylene glycol, polyethylene glycol selected from the group consisting of PEG-200, PEG-300, PEG-400, and PEG-600; 2-methoxyethanol, 2-ethoxyethanol, 2-propoxyethanol, 2-isopropoxyethanol, 2-butoxyethanol, 1-methoxy-2-propanol, 1-ethoxy-2-propanol, 3-methoxy-1-butanol, diethylene glycol monomethyl ether, diethylene glycol monoethyl ether, diethylene glycol mono-n-propyl ether, diethylene glycol mono-1-propyl ether, diethylene glycol monobutyl ether, triethylene glycol monomethyl ether, dioxane, glycerol, 3-methoy-1,2-propanediol, 3-ethoxy-1,2-propanediol, and mixtures of these solvents.

30. The process of claim 29 wherein said second solvent is selected from the group consisting of 2-isopropokyethanol, diethylene glycol, ethylene glycol, propylene glycol, PEG-200 and mixtures of these solvents.

31. The process of claim 26 wherein said preservative is selected from the group consisting of N,N-diethylhydroxylamine, ascorbic acid, erythrobic acid, sodium sulfite, potassium sulfite, and mixtures of these preservatives and said preservative is added to said first solution.

32. The stabilized solution of claim 26 wherein said preservative is selected from the group consisting of N,N-dialkylhydroxylamine, N,N-diethylhydroxylamine, ascorbic acid, erythrobic acid, sodium sulfite, potassium sulfite, and mixtures of these preservatives and said preservative is added to said second solution.

33. A process for preparing a stabilized solution of a p-phenylenediamine free base color developer which comprises the steps of:
a. hydrogenating a nitro or nitroso precursor compound of the p-phenylenediamine color developer free base in the presence of a hydrogenation catalyst and a first solvent selected from the group consisting of alkanols containing 1 to 6 carbon atoms, ethers containing 2 to 6 carbon atoms and mixtures thereof and under hydrogenation conditions of pressure and temperature to obtain a first solution of p-phenylenediamine color developer free base;
b. separating the heterogeneous catalyst from the first solution of p-phenylenediamine color developer free base;
c. crystallizing the p-phenylenediamine free base in said first solution;
d. recovering the crystallized p-phenylenediamine color developer;
e. dissolving the crystallized p-phenylenediamine color developer in a second solvent selected from the group consisting of at least one photographically inactive water-miscible or water-soluble, hydroxy-containing, organic solvent for the color developing agent in free base form to form a second solution; and
f. adding a p-phenylenediamine color developer free base preservative to the second solution.

34. The process of claim 33 wherein said precursor compound is selected from the group consisting of 4-nitroso-3-methyl-N-ethyl-N-(2-methanesulfonamidoethyl)aniline, 4-nitrdso-3-methyl-N-ethyl-N-(2-hydroxyethyl)aniline and mixtures thereof, and said p-phenylenediamine color developer free base is selected from the group consisting of N-ethyl-N-2-(methanesulfonylaminoethyl)-2-methyl-p-phenylenediamine, N-ethyl-N-2-(hydroxyethyl)-2-methyl-p-phenylenediamine and mixtures thereof.

35. The process of claim 34 wherein second solvent is selected from the group consisting of 2-propanol, 2-isopropoxyethanol, diethylene glycol, ethylene glycol, propylene glycol, PEG-200 and mixtures of these solvents.

36. The process of claim 33 wherein said preservative is selected from the group consisting of N,N-diethylhydroxylamine, ascorbic acid, erythrobic acid, sodium sulfite, potassium sulfite, and mixtures of these preservatives.

37. A process for preparing a solid stabilized p-phenylenediamine free base color developer which comprises the steps of:
a. hydrogenating a nitro or nitroso precursor compound of the p-phenylenediamine color developer free base in the presence of a hydrogenation catalyst and a solvent selected from the group consisting of alkanols containing 1 to 6 carbon atoms, ethers containing 2 to 6 carbon atoms and mixtures thereof and under hydrogenation conditions of pressure and temperature to obtain a solution of p-phenylenediamine color developer free base;
b. separating the heterogeneous catalyst from the solution of p-phenylenediamine color developer free base;
c. crystallizing the p-phenylenediamine free base in said first solution;
d. recovering the crystallized p-phenylenediamine color developer;
e. adding a non-volatile preservative to the recovered crystallized p-phenylenediamine color developer free base; and
f. drying the p-phenylenediamine color developer in the presence of said preservative.

38. The process of claim 37 wherein said precursor compound is selected from the group consisting of 4-nitroso-3-methyl-N-ethyl-N-(2-methanesulfonamidoethyl)aniline, 4-nitroso-3-methyl-N-ethyl-N-(2-hydroxyethyl)aniline and mixtures thereof, and said p-phenylenediamine color developer free base is selected from the group consisting of N-ethyl-N-2-(methanesulfonylaminoethyl)-2-methyl-p-phenylenediamine, N-ethyl-N-2-(hydroxyethyl)-2-methyl-p-phenylenediamine and mixtures thereof.

39. The process of claim 37 wherein said preservative is selected from the group consisting of N,N-diethylhydroxylamine, ascorbic acid, erythrobic acid, sodium sulfite, potassium sulfite, and mixtures of these preservatives.

40. The process of claim 37 wherein said heterogeneous catalyst is separated from the solution of p-phenylenediamine color developer free base by filtration.

41. The process of claim 37 wherein said solvent is selected from the group consisting of methanol, ethanol, tetrahydrofuran, 1-propanol, 2-propanol and mixtures thereof.
